(19) United States
(12) Patent Application Publication
(10) Pub. No.: US 2014/0074581 A1
(43) Pub. Date: Mar. 13, 2014

(54) SYSTEMS, METHODS, AND COMPUTER PROGRAM PRODUCTS FOR MANAGING SERVICE PROVIDER LOYALTY PROGRAMS

(71) Applicant: JVL VENTURES, LLC, New York, NY (US)

(72) Inventors: Kai P. Johnson, San Diego, CA (US); Todd A. Strickler, Rockville, MD (US); Robert C. Sprogis, Oak Hill, VA (US); Gordon C. Saussy, Potomac, MD (US); Joseph Morris, Monsey, NY (US)

(73) Assignee: JVL VENTURES, LLC, New York, NY (US)

(21) Appl. No.: 13/975,583

(22) Filed: Aug. 26, 2013

Related U.S. Application Data
(60) Provisional application No. 61/700,491, filed on Sep. 13, 2012.
(60) Provisional application No. 61/700,496, filed on Sep. 13, 2012.

(51) Int. Cl. G06Q 30/02

(52) U.S. Cl. CPC G06Q 30/0233
USPC 705/14.33

(57) ABSTRACT

Methods, systems and computer program products are provided for managing service provider loyalty programs. Loyalty program information associated with a service provider is generated. The loyalty program information defines a loyalty program. An electronic loyalty card based on the loyalty program is stored at the mobile device after enrollment of the mobile device. The loyalty program information associated with the loyalty card is enabled to be redeemed at a transaction location, and the loyalty program information is reconciled between the service provider and the mobile device.

### CROSS-REFERENCE TO RELATED APPLICATIONS

This application claims priority to U.S. Provisional Application No. 61/700,491, filed Sep. 13, 2012, and to U.S. Provisional Application No. 61/700,496, filed Sep. 13, 2012, the contents of which are incorporated herein by reference.

### BACKGROUND

I. Field

Example aspects of the present invention generally relate to managing service provider loyalty programs.

II. Related Art

Typically, merchants manage loyalty programs with consumers via physical cards sent by physical mail or handed out in person. For example, a retail sales clerk may prompt a consumer making a purchase to join a loyalty program by filling out a form, after which the consumer receives the loyalty card.

However, such traditional channels have limited effectiveness. For example, physical loyalty cards can be lost, overlooked or discarded by consumers. Moreover, even if a consumer wishes to join a loyalty program or redeem benefits therefrom, the process is often inconvenient. For example, the consumer must carry multiple cards for different merchants, and search through the cards at the time of transaction. In addition, each loyalty card may only store a minimum of information, reducing usefulness.

### BRIEF DESCRIPTION

The example embodiments described herein address the above-identified needs by providing methods, systems and computer program products for managing service provider loyalty programs. Loyalty program information associated with a service provider is generated. The loyalty program information defines a loyalty program. An electronic loyalty card based on the loyalty program is stored on the mobile device after enrollment of the mobile device. The loyalty program information associated with the loyalty card is enabled to be redeemed at a transaction location, and the loyalty program information is reconciled between the service provider and the mobile device.

### BRIEF DESCRIPTION OF THE DRAWINGS

The features and advantages of the example embodiments of the invention presented herein will become more apparent from the detailed description set forth below when taken in conjunction with the following drawings.

FIGS. 1A to 1C are representative views of a system in which some embodiments of the invention may be implemented.

FIG. 2 is a flowchart diagram illustrating an exemplary procedure for managing service provider loyalty programs.

FIG. 3 is a representative view for illustrating a life cycle of a loyalty program.

FIG. 4 is a flowchart diagram illustrating an exemplary procedure for redeeming an offer and/or loyalty program data.

FIG. 5 is a flowchart diagram illustrating an exemplary procedure for redeeming loyalty points for cash.

FIGS. 6A and 6B are representative views of interfaces presented to a consumer according to an example embodiment.

FIG. 7 is a representative view of interfaces presented to a consumer according to an example embodiment.

FIG. 8 is a block diagram of a device for use with various example embodiments of the invention.

### DETAILED DESCRIPTION

The example embodiments of the invention presented herein are directed to methods, systems and computer program products for managing service provider loyalty programs. This description is not intended to limit the application of the example embodiments presented herein. In fact, after reading the following description, it will be apparent to one skilled in the relevant art(s) how to implement the following example embodiments in alternative embodiments, such as a web-services or web media-based environment, etc.

For simplicity, the system acting as the intermediary between partners (merchants) and consumers is referred to as a mobile commerce (MoCom) platform or MoCom system. The invention is not necessarily limited to mobile devices, and other designations are possible. In addition, while the construct for storing the user's MoCom information is referred to as a wallet application or electronic wallet, it should be understood that other constructs are possible, including an independent loyalty program application, an application running on behalf of a merchant, and so on. Moreover, a merchant who provides loyalty programs and/or offers may be referred to as a “service provider” or “partner”, depending on context. Additionally, “consumer” and “user” are used interchangeably depending on context.

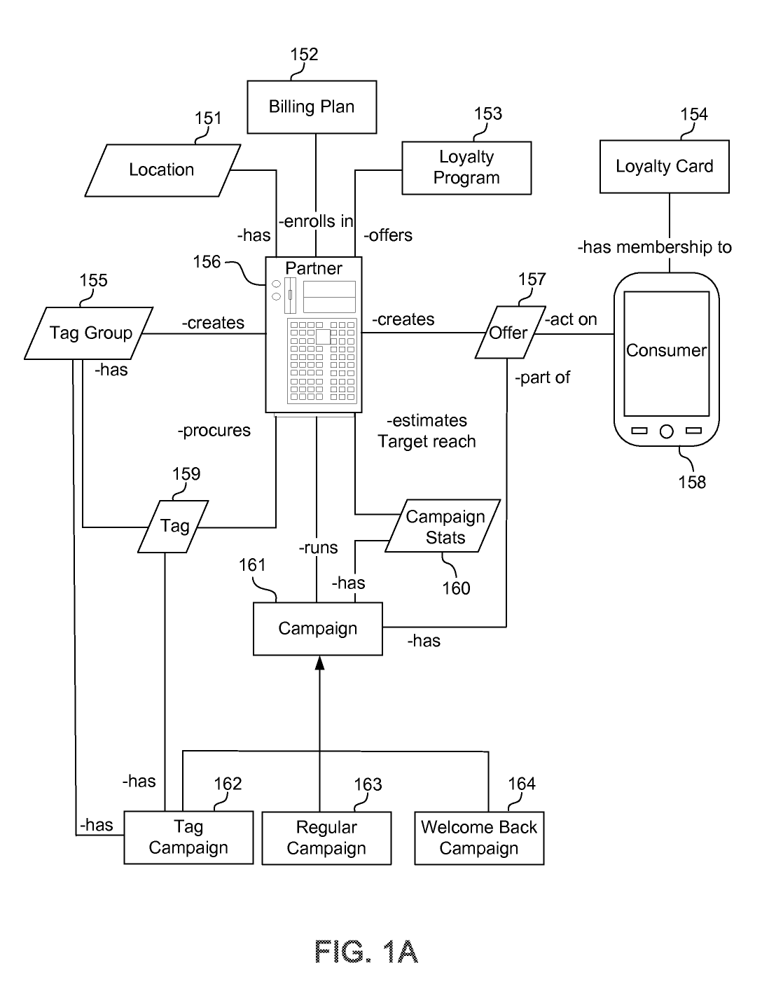

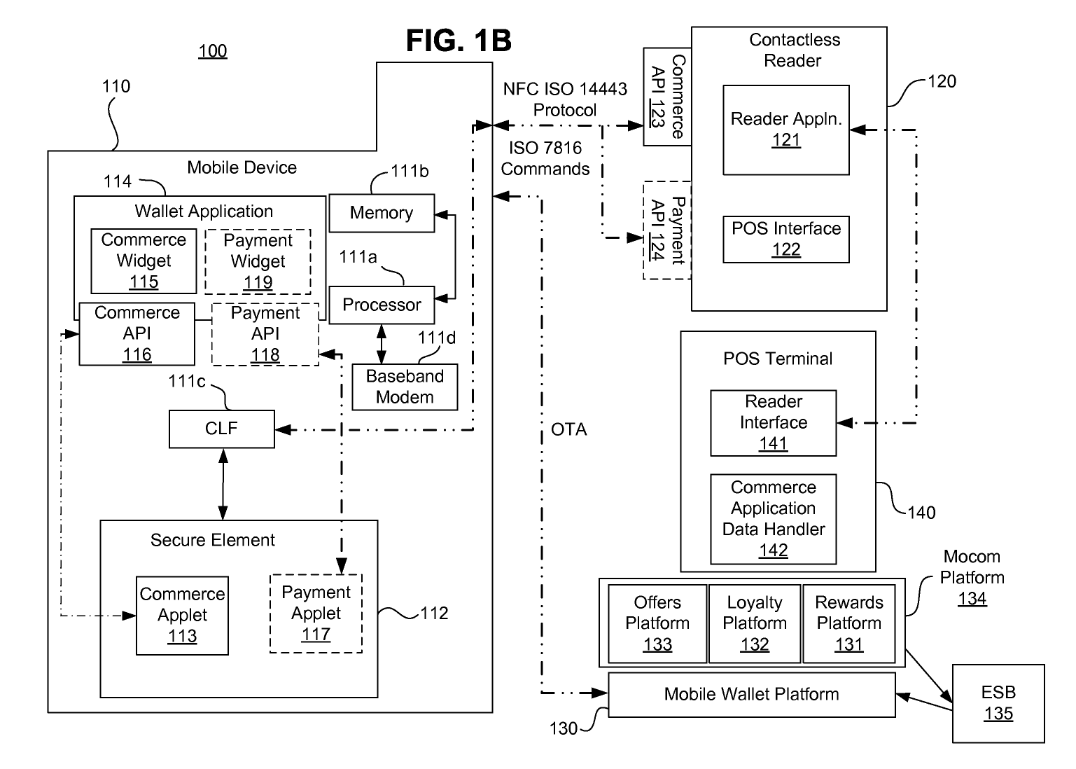

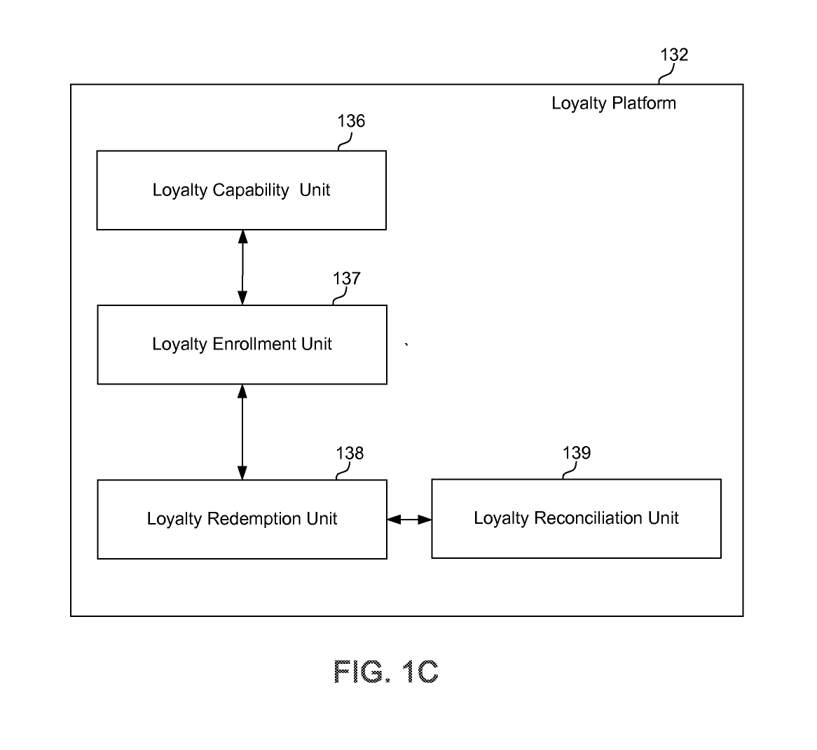

FIG. 1A is a representative view of a system in which some embodiments of the invention may be implemented.

In particular, FIG. 1A depicts an overall example of interactions between consumers and partners facilitated by the MoCom platform according to an example embodiment.

Briefly, as shown in FIG. 1, partner system 156 (hereafter “partner” 156) is a server computer or a system or network of computers operated by a service provider or merchant who provides goods or services to consumers. According to one example embodiment, partner 156 may be, for example, a retail or online merchant, who creates offer 157 for consumer 158 to act on. Consumer device 158 (hereafter “consumer 158”) is a mobile device or other computing device which is operated by customers of partner 156. Offer 157 is a data object which corresponds to a coupon, discount, or other benefit provided to consumer 158, ordinarily subject to terms and conditions (e.g., a 20% discount when a purchase exceeds $50.00).

Partner 156 also offers loyalty program 153 to consumer 158. Loyalty program 153 may include, for example, a membership card or number corresponding to the partner by which a consumer receives discounts and offers associated with partner 156, or accumulates benefits associated with transactions. According to some aspects of the invention, an offer may be tied to a loyalty program. However, this arrangement is not required. For example, even if a transaction is not attached to a particular offer, loyalty data can still be transmitted independently, so that the consumer earns loyalty points or other benefits on the transaction.

In that regard, consumer 158 has an electronic loyalty card 154 corresponding to partner 156, so that the consumer can receive discounts and/or offers from partner 156. In that regard, loyalty card 154 does not necessarily need to be a physical card, and can instead simply correspond to data indicating a relationship between consumer 158 and partner 156, as discussed more fully below.

Tag 159 is a data object which may correspond to a visual object which may be read and displayed on a mobile device or other computing device, and which may be tied to one or more offers. Campaign 161 is a procedure, algorithm or other program by which an offer is provided to consumers.

Referring again to FIG. 1A, partner 156 runs campaign 161. A campaign 161 is an offer program which is provided to consumers. In particular, campaign 161 has offer 157, which is provided to consumer 158. Consumer 158 acts on offer 157. In particular, consumer 158 is targeted as part of campaign 161 and may receive offer 157 via, for example, a mobile device. In some aspects, offer 157 is analogous to a coupon.

Partner 156 creates an offer 157 as part of campaign 161. Partner 156 has location 151, which in some embodiments might be incorporated into the conditions of the offer, e.g., only providing the offer to consumers within a certain range near partner location 151. Partner 156 enrolls in a billing plan 152 according to an example embodiment, to pay for services included in presenting offers and/or loyalty programs to consumers.

As explained above, campaign 161 is an offer program that has offer 157, which is provided to consumers. In other words, campaign 161 is the vehicle by which offers are presented to a consumer. According to one example embodiment, an offer must be tied to a campaign, and the campaign conditions/attributes determine which consumers receive the offer, and under what circumstances. Campaign 161 may comprise, for example, a tag campaign 162 which is based on visible tags. For example, tag campaign 162 may include tag 159, which has a tag group 155. In this example, partner 156 creates tag group 155, and procures tag(s) 130 corresponding to the offer. Campaign 161 may also comprise a “regular” campaign 163, which can correspond to, for example, a coupon offer or loyalty program offer, e.g., 20% off all purchases once 500 loyalty points are accumulated.

Campaign 161 may also comprise a welcome back campaign 164, which is based on a consumer's usage of a loyalty program after a prolonged absence, or which may also be offered to consumers new to the loyalty program. Campaign 161 has campaign statistics 160, which may be estimated by partner 156 to determine, for example, the reach and/or cost of campaign 161.

FIG. 1B is a graphical representation of a MoCom platform architecture in accordance with an exemplary embodiment. As shown in FIG. 1B, system 100 includes a mobile device 110 communicatively coupled to a contactless (e.g., proximity or NFC) reader 120 and a mobile wallet platform 130. Reader 120 also is communicatively coupled to a POS terminal 140. POS terminal 140 may be within the same housing as reader 120. Alternatively, POS terminal 140 and reader 120 are communicatively coupled with each other but each of these components is housed separately.

Mobile device 110 may be, for example, a cellular phone or the like, and includes a processor 111a, memory 111b, a contactless frontend (CLF) 111c, a baseband modem 111d, and a user interface such as a display (not shown). Baseband modem 111d is a digital modem that is used for mobile network communications. CLF 111c is circuitry which handles the analog aspect of contactless or NFC communications and the communication protocol layers of a contactless transmission link. CLF 111c also is used to exchange data between reader 120 and a secure element (or SE) 112 contained in mobile device 110, for example, to execute contactless transactions.

Secure element 112 may be implemented as a Universal Integrated Circuit Card (UICC), embedded SE card, secure micro secure digital (microSD) card, and the like. Secure element 112 is generally considered secure because it is a self-contained system, including dedicated memory, and is protected by hardware and software hardening techniques that are verified by independent testing.

Secure element 112 includes (e.g., stored thereon) one or more commerce applets 113. A commerce applet 113 may be associated with one or more commerce services and/or accounts issued by a commerce service provider (SP). A service provider is a company, organization, entity, or the like, that provides services to customers or consumers. Examples of service providers include account-issuing entities such as banks, merchants, card associations, marketing companies, and transit authorities. A service may be an activity, capability, functionality, work, or use that is permitted or provided by a service provider, such as a payment service, credit, debit, checking, gift, offer or loyalty service, transit pass service, and the like.

A commerce service provider can utilize one or more commerce applets 113 in a contactless transaction. Other service providers can utilize the same or other commerce applets 113 on the secure element 112. Generally, a commerce applet 113 can be instantiated and personalized with data related to loyalty and offers, thereby providing an APDU interface through which this data can be managed to conduct a contactless transaction. Commerce applet 113 operates as a generic storage container, allowing multiple loyalty/offer services to share mechanisms (e.g., secure element, mobile device) for loyalty and/or offer data management, for example, by instantiating and personalizing a commerce applet which, in turn, is used by a commerce service provider to execute a contactless transaction. If memory restrictions and performance requirements limit the amount of loyalty/offers data that can be stored on secure element 112, additional data can be stored in mobile device memory 111b and managed by the consumer via commerce widget 115. For example, any graphic images related to an offer can be stored in memory 111b in order to optimize secure element memory allocation. Loyalty/offers data management can be handled by the corresponding offer platform 131, loyalty platform 132, or rewards platform 133.

Commerce applet 113 may include a cached merchant data table enabling the storage and/or management of data related to one or more merchants. This table allows the commerce data for one or more merchants to be loaded within the secure element 112 or mobile device 110 by a wallet application, thereby providing efficient access to and querying of the stored data to perform transactions. This data may be stored in a record oriented data buffer. In an exemplary embodiment, a merchant identifier is used as the key field for search/retrieval tasks. Optionally, an index (or hash table) may be created to improve performance.

A commerce applet 113 (or, alternatively, multiple commerce applets 113) can be loaded onto the secure element 112, for example, during manufacture and/or configuration of the secure element 112 and may, in turn, be instantiated and personalized to enable its use to conduct commerce transactions. A table can be used to store merchant and/or consumer data for use in a commerce transaction. Such merchant and/or consumer data may include, but is not limited to, a merchant's store address, store phone number, store contact name, store contact phone number, store contact email address, store fax number, a number of check-out lanes, payment terminal manufacturer(s), payment terminal model number(s), whether contactless transactions are employed at the store location, payment terminal parameters or ECR parameters, and the store location. A commerce applet 113 interfaces with reader 120 via a commerce application programming interface (API) 123. In an exemplary embodiment, a commerce applet 113 is in the form of a JavaCard applet and is accessible through the use of APDU commands as defined in ISO 7816-4. Particularly, commerce applet 113 communicates commerce elements to reader 120 via secure element 112 using ISO 7816 commands over the NFC ISO 14443 protocol.

Secure element 112 can also include one or more payment applets 117 where each payment applet 117 is associated with a payment service and an account issued by a payment service provider. One or more payment applets 117 also can be loaded onto the secure element 112, for example, during manufacture and/or configuration of the secure element 112, and may be personalized to enable its use to conduct payment transactions. A payment applet 117 interfaces with reader 120 via API 124. In an exemplary embodiment, payment applet 117 is in the form of a JavaCard applet and is accessible through the use of APDU commands as defined in ISO 7816-4. Payment applet 113 also communicates payment elements to reader 120 via secure element 112 using ISO 7816 commands over the NFC ISO 14443 protocol.

It should be understood that other communications between the aforementioned devices may include communications with or through other intervening systems, hardware, and/or software, and such communications may include receiving, transferring, and/or managing data.

A wallet application 114 stored on mobile device 110 includes instructions which, when executed by the processor of the mobile device 110, cause the mobile device 110 to act as an instrument, for example, for processing transactions such as contactless commerce and/or payment transactions. Wallet application 114 communicates, through the use of APDU commands as defined in ISO 7816-4, with the commerce applet 113 via commerce API 116 and to payment applet 117 via payment API 118.

Commerce widget 115 is a component of the wallet application 114 that provides an interface for consumers to manage commerce elements (e.g., loyalty card credentials, offers and rewards), for example, through interactions with the display or user interface of a mobile device. Commerce widget 115 maintains, for example, a master list of commerce elements present on the handset in a memory of the mobile device (e.g., 111b). A subset of offers that have been identified as ready to be used are, in turn, moved to secure element 112 to be communicated to contactless reader 120 and POS terminal 140. Sensitive information, such as loyalty account identifiers can be stored on secure element 112. While some embodiments include commerce widget 115, it should be understood that the invention is not so limited. For example, commerce widget 115 could be replaced with a commerce software component comprising instructions which, when executed by a processor, provide additional functionality associated with the wallet application.

Payment widget 119 is a component of the wallet application 114 that provides an interface for consumers to manage payment elements (e.g., credit or debit card credentials), for example, through interactions with the display or user interface of a mobile device. While some embodiments include payment widget 119, it should be understood that the invention is not so limited. For example, payment widget 119 could be replaced with a payment software component comprising instructions which, when executed by a processor, provide additional functionality associated with the wallet application.

Reader 120 includes a reader commerce application 121 (referred to herein simply as a “reader application”) and a POS interface 122. Reader 120 manages two interfaces: one interface is with the secure element 112 in the mobile device 110 and the other interface is with POS terminal 140 which includes a reader interface 141 and a commerce application data handler 142. The functionality of reader 120 is the same whether reader 120 is standalone and connected to a payments terminal or merchant POS, or is integrated therein. Contactless payment functionality is also contained in reader 120 but is not shown.

Mobile device 110 is further communicatively coupled to a mobile wallet platform 130, which in turn is communicatively coupled to offers platform 131, loyalty platform 132 and rewards platform 133. Collectively, offers platform 131, loyalty platform 132 and rewards platform 133 can be referred to as a mobile commerce (MoCom) platform 134 and are implemented on one or more servers, referred to herein individually and collectively as a MoCom server. Meanwhile, MoCom platform 134 and mobile wallet platform 130 interact via Enterprise Service Bus (ESB) 135 which acts as an intermediary between the mobile wallet platform 130 and external party systems.

In one embodiment, a customer may use mobile device 110 to conduct a contactless transaction at a POS equipped with reader 120. The customer places the mobile device 110 within a predetermined required proximity of the contactless reader 120 (i.e., taps) causing CLF 111c of the mobile device 110 to communicate with reader 120 using, for example, NFC ISO 14443 protocols. Reader 120 also communicates with wallet application 114, commerce applet 113, and/or payment applications on the mobile device 110 to execute contactless transactions, such as redeeming an offer.

A secure element employs a Proximity Payment System Environment (PPSE) that serves as a directory of available credentials currently stored in secure element 112. Each credential is assigned a corresponding application identifier (AID) associated with a payment application and stored in the PPSE. When an NFC-enabled mobile device containing secure element 112 is placed in the vicinity of an NFC-enabled contactless reader, the contactless reader reads the credential and completes the transaction. Before doing so, however, the reader is initialized.

On mobile device 110, PPSE is an application used to maintain a list of payment applications stored on secure element 112, and provides accessibility to each payment application stored on the mobile device 112 by making them visible or not visible (i.e., accessible) to systems or devices.

Additional details of facilitating a transaction between a consumer, a partner and the MoCom system can be found in exemplary embodiments described in U.S. application Ser. No. 13/901,134 and U.S. application Ser. No. 13/901,188, both filed on May 23, 2013 and both entitled “Systems, Methods and Computer Program Products for Providing a Contactless Protocol”, and incorporated herein by reference in their entirety.

FIG. 1C is a block diagram for explaining aspects of loyalty platform 132. In particular, as shown in FIG. 1C, loyalty platform 132 includes loyalty capability unit 136, loyalty enrollment unit 137, loyalty redemption unit 138, and loyalty reconciliation unit 139. Loyalty capability unit 136 generates loyalty program information associated with a service provider. The loyalty program information defines a loyalty program. Loyalty enrollment unit 137 enrolls a consumer's mobile device. An electronic loyalty card based on the loyalty program is stored at the mobile device after enrollment of the mobile device. Loyalty redemption unit 138 enables redemption of loyalty program information associated with the loyalty card at a transaction location, and loyalty reconciliation unit 139 reconciles the loyalty program information between the service provider and the mobile device. Each of these processes is described more fully below.

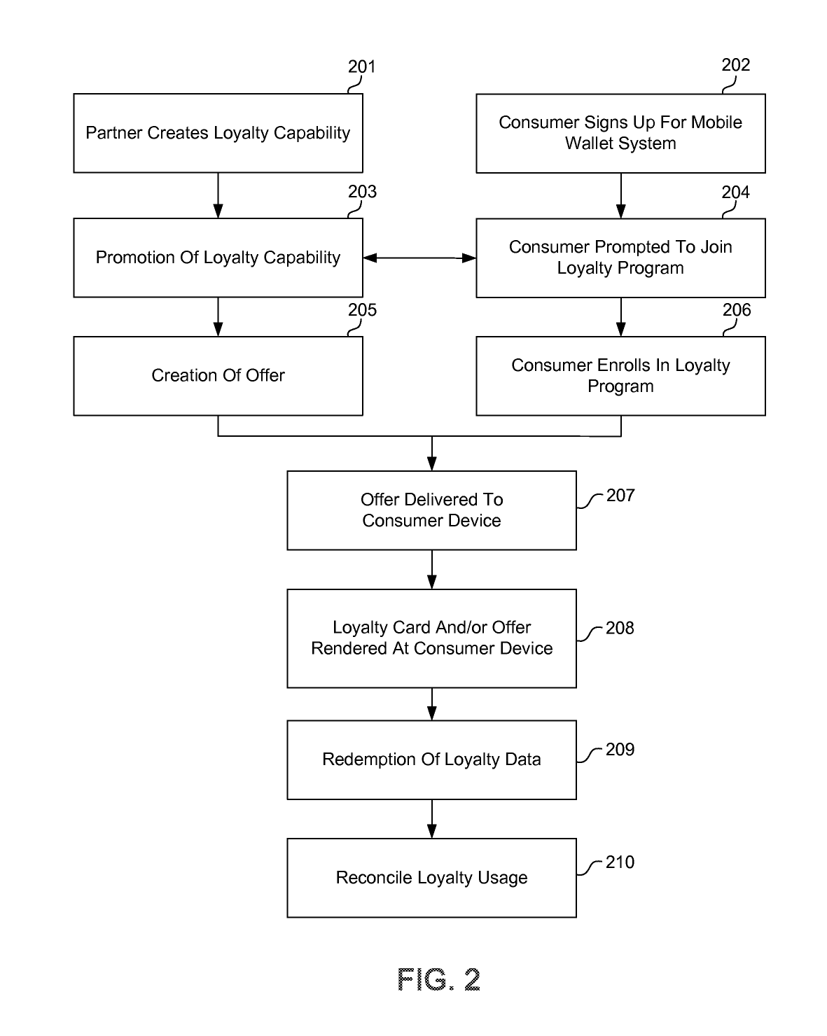

FIG. 2 is flowchart diagram illustrating an exemplary procedure for managing service provider offers.

Briefly, in FIG. 2, loyalty program information associated with a service provider is generated. The loyalty program information defines a loyalty program. An electronic loyalty card based on the loyalty program is stored at the mobile device after enrollment of the mobile device. The loyalty program information associated with the loyalty card is enabled to be redeemed at a transaction location, and the loyalty program information is reconciled between the service provider and the mobile device.

In more detail, in step 201, a partner creates loyalty capability in the MoCom system. In particular, the partner may communicate with a MoCom server or other device to join the MoCom loyalty card system. For example, an administrative web interface may be provided by the MoCom system to allow a partner to enroll in the system.

In step 202, a consumer signs up for a mobile wallet system, such as one provided by the MoCom system. The user may, for example, sign up directly via the mobile device after receiving a prompt or installing an application, or may sign up independently via, for example, a website.

In step 203, the loyalty capability of the partner is promoted to consumers and users in the MoCom system. For example, icons and messages may be displayed in a corresponding merchant page accessible by the mobile device. Thus, a consumer can search for a particular merchant and seek out the corresponding loyalty card.

In another example, an information “feed” or other series of information may be distributed to a mobile device enrolled in the MoCom system, and the feed may include the partner's loyalty information. For example, the feed may include a message stream of notifications of activities performed and other significant events, such as new offers, offers about to expire, transactions performed, purchase or loyalty card operations performed, and more.

In still another example, an option or promotion for the loyalty program may be included in an offer catalog. Thus, when a user redeems an offer for a transaction, the user is also prompted to join the loyalty program for the corresponding merchant.

In step 204, the consumer is prompted to join the loyalty card program. In particular, after enrolling in the mobile wallet system, the consumer is further prompted to join the loyalty program for one or more partners. As shown in FIG. 2, the prompts to the consumer or consumer's mobile device may be in correspondence with the promotions being performed in step 203.

In step 205, the partner may create one or more offers to associate with the loyalty program. In this regard, often loyalty card information is exchanged and redeemed in the context of a transaction or offer. For example, a consumer earns loyalty card points when a loyalty card is applied to a transaction, while at the same time receiving a discount due to an offer. In another example, the loyalty card benefits may not be tied to a particular offer, but rather to a certain amount of transactions over a period of time (e.g., 20% discount after earning 200 loyalty points).

In step 206, the consumer enrolls in a loyalty card program. The enrollment process may dynamically convert loyalty points to an electronic representation of a new prepaid card or gift card associated with the partner or merchant.

In one embodiment, a mobile wallet automatically recognizes that a consumer does not have a merchant loyalty card in his or her respective wallet. Immediately, or at a later time, the mobile wallet may prompt the consumer to enroll in a new merchant loyalty card, or to link an existing loyalty card to his or her respective mobile wallet.

A consumer may enroll a mobile device (or receive a link or prompt to enroll) in a merchant loyalty program and/or link an existing merchant loyalty program after, for example, tapping or moving the mobile device near a radio-frequency identification (RFID) tag or a near-field communication (NFC) tag, engaging in a transaction at a point of sale using near-field or contactless communication, or by “clipping” an offer from a website.

Thus, in one embodiment, after reading of an RFID tag, an NFC tag or other image, a mobile device prompts a consumer to enroll in a loyalty card program or to link an existing card to his or her mobile wallet. For example, the prompt may be provided on a display of the mobile device after the contactless transaction is initiated.

In another embodiment, a consumer may be prompted to enroll or link an existing loyalty card to his or her mobile wallet after a contactless or near-field communication transaction has been initiated. For example, a consumer may tap or move his or her mobile device at or near a terminal reader at a point of sale, and soon after receive a message in the mobile wallet. The message may be a prompt to the consumer to link an existing card or enroll a new loyalty card.

In still another embodiment, a consumer may select to “clip” an offer or other promotion, from a website, mobile application, RFID tag, NFC tag, or the like, and then receive a message in the mobile wallet prompting the consumer to link an existing card or enroll a new loyalty card.

In yet another embodiment, a feed, directory or other display on the mobile device provides a list of available loyalty programs, and the consumer selects from the list.

Thus, in various embodiments, the mobile device is enrolled with the loyalty program via a web page associated with the service provider, based on a list of service providers distributed to the mobile device, based on a prompt received after near-field communication between the mobile device and a reader at the transaction location, or based on a prompt received after reading an image with the mobile device.

Following enrollment, the loyalty card data, along with corresponding data such as credentials or loyalty card images, may be saved in a secure element on the consumer's mobile device.

In step 207, the offer is delivered to the consumer's mobile device. In one embodiment, the MoCom platform delivers the offer to a mobile wallet platform via an Enterprise Service Bus (ESB) which acts as an intermediary between the mobile wallet platform and external party systems, as discussed above. In some embodiments, the partner may direct the offer to the MoCom platform, and in some embodiments the partner may direct offers to a consumer's electronic wallet.

In step 208, loyalty card and/or offer are rendered at the consumer's mobile device. For example, the loyalty card data or offer may be sent to a page corresponding to the partner on the mobile device, to the aforementioned information feed, or to an offer view page on the mobile device. The loyalty card and/or offer may be represented as a barcode, as discussed more fully below, or may be depicted as another image or alphanumeric sequence.

In step 209, the consumer redeems the loyalty data for a corresponding transaction at a point of sale. As mentioned, the loyalty data can be redeemed with or without redemption of a corresponding offer. For example, even if a transaction is not attached to a particular offer, the loyalty data can still be transmitted, so that the consumer earns loyalty points or other benefits on the transaction. The redemption of loyalty information may occur via a contactless transaction between the mobile device and a reader terminal, or may occur by, for example, scanning a displayed barcode corresponding to the loyalty data.

In step 210, the loyalty usage is reconciled between the partner, the consumer, and the MoCom system. In one embodiment, the partner reconciles the loyalty data of the consumer by updating corresponding data in its own system or server. Meanwhile, the point of sale may send a batch file to the partner with all loyalty transactions within a certain period of time. The MoCom system may also reconcile with both partner and consumer in order to update the consumer's loyalty data in the mobile wallet.

In one embodiment, statistics from the reconciled data can be queried and received by the partner. For example, the partner can query the MoCom system for a number of consumers who have joined the loyalty program, the number of consumers who have presented or used loyalty cards over a given time, and the number of consumers who have modified or removed their loyalty card.

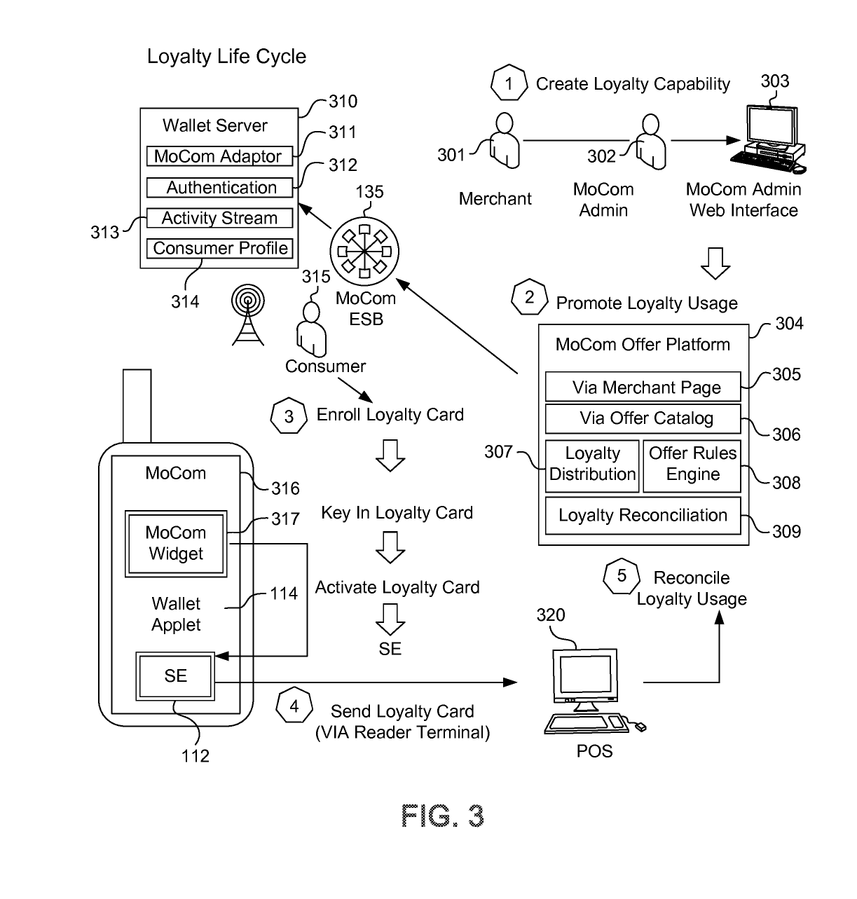

FIG. 3 is a representative view for illustrating a life cycle of the loyalty program described above with respect to FIG. 2.

In particular, FIG. 3 is an example illustration of transactions between different entities in the loyalty program system according to the present invention. As shown in FIG. 3, the life cycle begins in part 1, where the loyalty capability is created. In this example, merchant (partner) 301 communicates with MoCom administrator (i.e., “admin”) 302, who uses a MoCom admin web interface to create the loyalty capability for partner 301. Of course, this is only an example, and partner 301 may also enroll directly via another web interface or other methods.

In part 2, loyalty usage is promoted for the partner. In the example shown in FIG. 3, the MoCom platform 304 promotes the loyalty usage via merchant page 305, or via offer catalog 306. Loyalty distribution 307 may store information regarding targets of the promotion, such as consumers who have signed up for the MoCom system or who have searched for the corresponding merchant. MoCom platform 304 communicates with a wallet server 310 corresponding to consumer 315 via ESB 135, described above. MoCom platform 304 may further include an offer rules engine for managing rules associated with offers corresponding to loyalty programs, e.g., whether an offer has expired or a consumer is otherwise ineligible. Loyalty reconciliation 309 reconciles loyalty data between consumer, partner and the MoCom system after a point of sale transaction.

Wallet server 310 includes a MoCom adaptor 311 for communication with MoCom platform 304, an authentication element 312 for authenticating the received promotional data and/or consumer 315, an activity stream 313 for receiving and displaying data from MoCom platform 304 such as loyalty card promotions, and consumer profile 314 which includes profile or account data corresponding to consumer 315.

In part 3, consumer 315 enrolls in a loyalty card program, as described above with respect to FIG. 2. In this example, the user keys in loyalty card information on mobile device 316 in order to activate the loyalty card, and the corresponding loyalty card information is stored in secure element 112. Wallet applet 114 manages data associated with offer and loyalty programs, and MoCom widget 317 manages communication with the MoCom system.

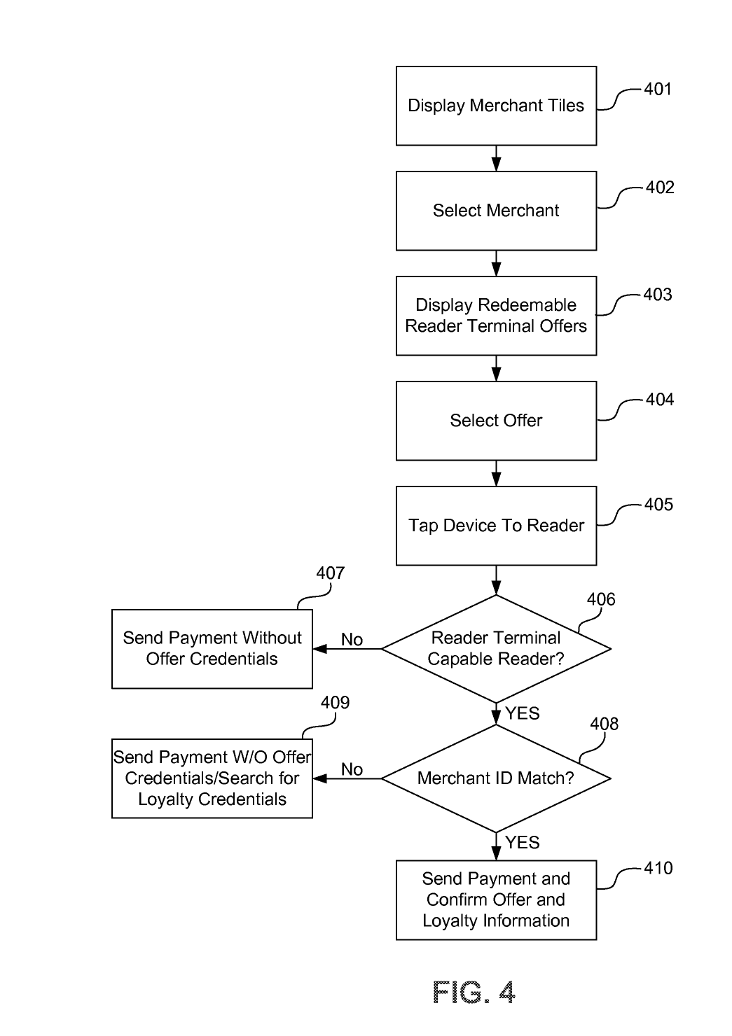

In part 4, as part of a point of sale transaction, mobile device 316 sends loyalty card information from secure element 112 to a point of sale 320, as described more fully below with respect to FIG. 4.

In part 5, the loyalty usage is reconciled with Mocom offer platform 304, and specifically via the loyalty reconciliation element 309.

FIG. 4 is a flowchart diagram illustrating an exemplary procedure for redeeming a loyalty card, with or without a corresponding offer. Specifically, FIG. 4 is a flowchart for explaining a redemption system in which a consumer can tap or move a mobile device at or near a reader terminal at, for example, a merchant location, in order to redeem a loyalty card and/or an offer which is redeemable by such a contactless system (hereafter referred to as “reader terminal offers”). The reader terminal may implement a protocol in accordance with exemplary embodiments described in U.S. application Ser. Nos. 13/901,134 and 13/901,188, both filed on May 23, 2013 and both entitled “Systems, Methods and Computer Program Products for Providing a Contactless Protocol”, and incorporated herein by reference in their entirety.

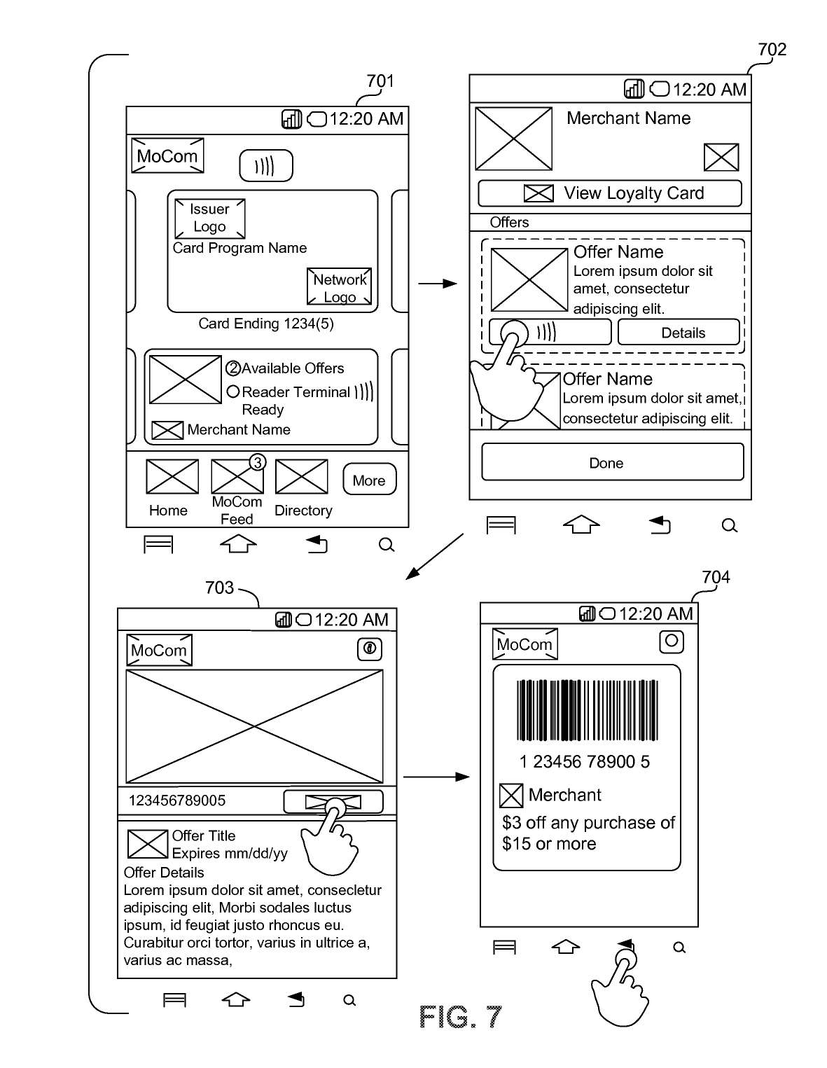

In step 401, merchant tiles are displayed on the mobile device. The merchant tiles are images corresponding to each merchant. FIG. 7 shows an example of such merchant tiles in view 701. In particular, view 701 depicts a home screen including information for the consumer such as a bank card program and a balance for the bank card.

View 701 also depicts a “Pharmacy” tile for a merchant, in a strip of merchant tiles from which a consumer can select. Thus, for example, the consumer may swipe through the tiles, left and right, to find a merchant. There is a tile present for every merchant that has a redeemable offer or loyalty card. As shown in view 701, the merchant tile for “Pharmacy” also indicates the total number of available offers, the number of reader terminal offers, and whether the loyalty card has been activated.

In step 402, the consumer selects a merchant. For example, the user may tap the merchant tile in order to open a merchant offer or loyalty card view. Generally, the user will select a merchant and offers prior to making a transaction, even if immediately prior, e.g., while waiting in line or while browsing in the store.

In step 403, reader terminal offers are displayed. As mentioned above, reader terminal offers correspond to offers which can be accomplished via the aforementioned contactless protocol.

In particular, as shown in FIG. 7, view 702, a merchant offer view lists offers for a particular merchant. Offers which are not redeemable via contactless communication at the reader terminal may also be displayed in the merchant offer view. If the selected merchant is not a reader terminal offer-capable merchant, an option to load offers for reader terminal redemption may not be presented. If the merchant is a reader terminal redemption merchant (as shown for the “Pharmacy” in view 702), the reader terminal redemption logo is shown and the listed offers feature a button to load. In that regard, individual stores may or may not support reader terminal offers, and may, for example, display a reader terminal logo at the point of sale to indicate compatibility.

The merchant offer view 702 restricts the view to redeemable offers only—that is, non-redeemable promotions ore expired offers are not shown. If present, a loyalty card may also be noted, as shown in view 702.

In step 404, a user selects an offer. For example, referring to view 702, the user can select a reader terminal offer by tapping the corresponding reader terminal button for a displayed offer, and then tapping the “done” bar at the bottom of the screen. The “done” bar is a trigger to load the selected offers into a secure storage element on the consumer's device (e.g., secure element 112). In some embodiments, if space is limited in the storage element, offers from another merchant may be removed at the same time new offers are loaded, thus saving space and ensuring that there are only offers from one merchant present in the storage element at any given time.

In step 405, the consumer taps the user's device to the reader, or moves it within a particular close distance of the reader. In particular, in one example, the user taps his/her mobile phone to a reader at a point of sale. Thus, a consumer redeems the loyalty program information during a corresponding transaction by moving the mobile device near a reader at the transaction location. Of course, other environments are possible.

In step 406, there is a determination of whether the reader is capable of using the reader terminal redemption system for offers or loyalty card. For example, a point of sale reader at a merchant location may be compatible with tapping the phone for payment, but not specifically compatible with the reader terminal offer system. In other words, a payment application may be active, but the reader terminal offer system may not be.

In step 407, if the reader is not compatible with the contactless protocol insofar as offers or loyalty information, the selected payment card information is sent, but no offers or loyalty credentials are sent. The user sees a post-tap message indicating that payment credentials were sent, with no other information. Tap time will be short (under 500 milliseconds typically) as only payment applets are active.

Meanwhile, if the reader is capable of contactless redemption of offers and/or loyalty information, there is a determination of whether the merchant ID for the selected offer matches the selected merchant. In particular, the first step in a reader terminal system is for the point of sale reader to send the “merchant ID” to a reader terminal applet (or other process) on the user device. The applet receives the merchant ID and compares it to the selected merchant ID. For example, there is a determination of whether the user at a pharmacy has actually selected an offer corresponding to the pharmacy.

In step 409, if the reader is capable of contactless redemption of offers and/or loyalty information but the merchant-ID does not match the selected merchant, offers will not be sent. The reader terminal redemption applet in the secure element will still look for a loyalty card for this merchant-ID, and will transmit loyalty credentials if present. The user sees a post-tap message indicating that a reader terminal transaction took place, identifying the merchant and reporting that loyalty credentials were sent (if they were available) as well as the payment credentials. Tap time may be the longest in this scenario—potentially over one second.

On the other hand, if the tapped reader is capable of contactless redemption of offers and/or loyalty information and the merchant ID for the offer matches the selected merchant, the process proceeds to step 410, where selected offers and (if present) the loyalty card for the merchant will be sent. The user sees a post-tap message confirming the merchant, confirming that offers and loyalty (if present) were sent, along with payments. Tap time is probably slightly under one second in this scenario. Thus, in the foregoing example, the consumer device is a mobile device, and the consumer redeems the offer during a corresponding transaction by moving the mobile device near a reader at the transaction location. Moreover, loyalty program information is transmitted at a transaction by the mobile device, along with redemption of an offer provided by the service provider. In addition, the loyalty program information is transmitted sequentially prior to or following payment information, in a single transaction.

Afterwards, the offers that were loaded into the storage element can be left in the storage element until the consumer removes them or selects offers from another merchant. Alternatively, if the offers expire, they can be removed from the storage element by a maintenance application running on the MoCom platform. The selected merchant will remain the “active” merchant on the consumer's home page until the user selects a different merchant.

In some aspects, space on the consumer's storage element (e.g., a non-volatile memory on the user's mobile phone) may be limited. Accordingly, it is ordinarily helpful to conserve space on the storage element by, for example, (i) loading offers into the storage element, (ii) unloading offers out of the storage element to make room for others and (iii) helping the user avoid exhausting the available space unintentionally. In addition, the process of writing the offers to the storage element may take time. As such, it is ordinarily useful to notify a user or allow a user control over storage element transactions such as loading offers, so that the user is not frustrated by, for example, blocking activity by the MoCom platform during the process of loading the offers. In addition, once the merchant ID is matched, the reader terminal applet must build a package of data for the point of sale (essentially a buffer or set of buffers including offers and loyalty data). Time can be saved by pre-building the buffer, but this uses some memory space in the secure storage element.

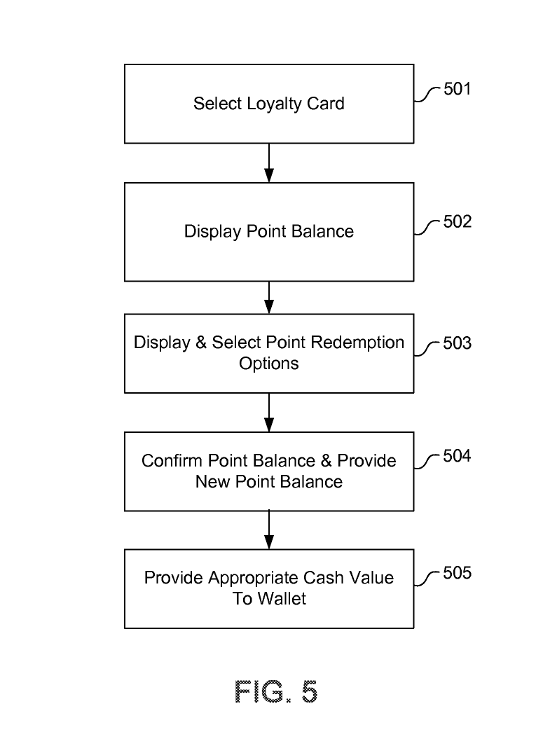

FIG. 5 is a flowchart diagram illustrating an exemplary procedure for redeeming loyalty points for cash. Conventionally, loyalty points are converted to a statement credit or to a physical prepaid or gift card which are delivered to the consumer via postal mail, increasing expense and delay.

However, according to the exemplary procedure in FIG. 5, a consumer can redeem loyalty program information for monetary value from the consumer's mobile device. In certain embodiments, cash value in a mobile wallet on the consumer's mobile device is represented as a credit on a preexisting card or account in a mobile wallet, or may be represented as a new prepaid or gift card which is provisioned to the mobile wallet. The redemption of loyalty points may be limited to specific merchants, and may require a threshold number of points. The cash value may, for example, be determined based on the number of loyalty points to be converted, and, if desired, an associated cash value of each loyalty point. Additionally, regardless of whether the cash value is in the form of a preexisting card or on a new prepaid or gift card, the cash value may be used to conduct other transactions in connection with the mobile wallet.

In some embodiments, the consumer may view the number of loyalty points accumulated in the electronic wallet on the mobile device and/or the cash value of the loyalty points. The user may convert all or a portion of the loyalty points into credit on an existing card or a new prepaid or gift card in the mobile wallet, which can then be immediately used.

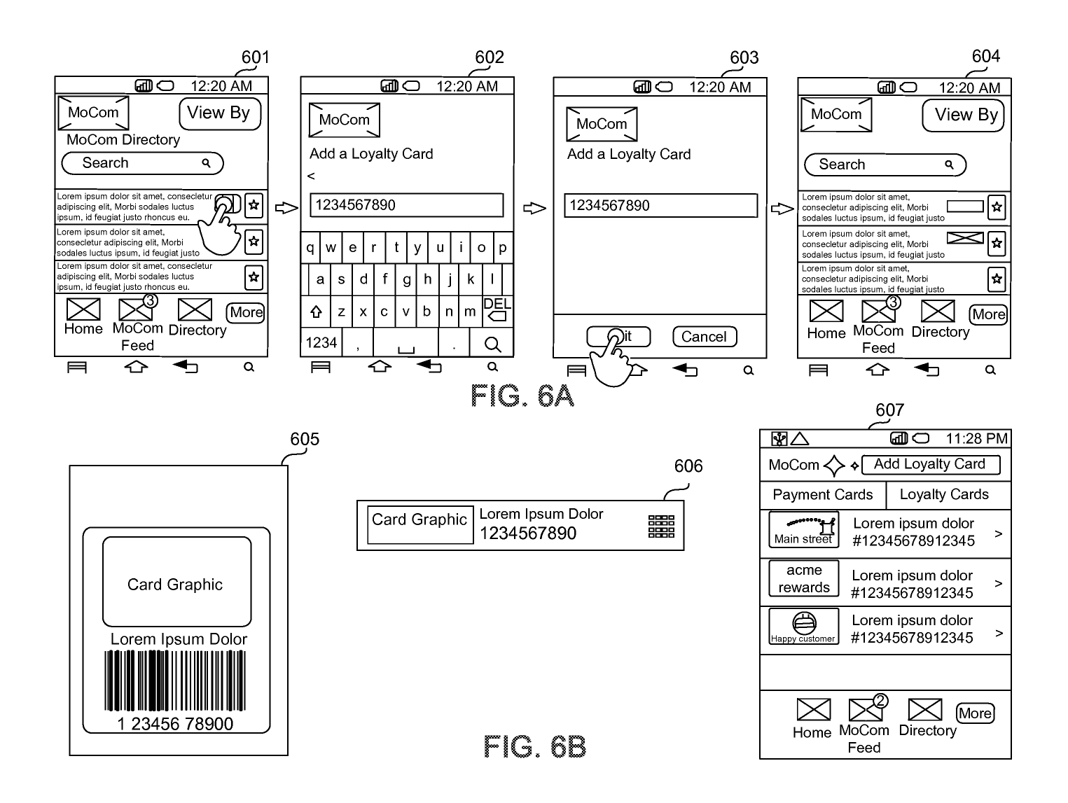

Turning to FIG. 5, in step 501, a loyalty card is selected. For example, a consumer may select an icon or graphic corresponding to a particular merchant and loyalty card from a list of merchants displayed on the mobile device, as shown generally in items 604, 606 and 607 in FIG. 6B.

In step 502, the point balance corresponding to the selected loyalty card is displayed. For example, in one embodiment, an electronic wallet application(s) on the mobile device requests a point balance from the merchant corresponding to the selected card, after transmitting a loyalty card ID corresponding to the consumer. A server computer or other device at the merchant may then retrieve the point balance and return it to the electronic wallet, which displays the point balance received. In some examples, the merchant or service provider may notify the consumer that the loyalty points are available for conversion to cash upon reaching a predetermined threshold number of loyalty points.

In step 503, there is display and selection of point redemption options. In some examples, if enough points have been registered to the loyalty card for redemption of a cash value, the user may be offered an option to that effect. There may also be display of the number of points required for redemption to one or more cash values. Options presented to the consumer via the display on the mobile device may include, for example, crediting points against an existing card in the mobile wallet or a merchant prepaid card or gift card, an amount of cash redemption, and, in some embodiments, sending the cash value as a gift to a friend, e.g., to a friend's electronic wallet. The electronic wallet may further ask (and receive) confirmation from the consumer for any of these options.

In step 504, the electronic wallet informs the merchant server or device of the point redemption including the number of points being redeemed, and requests an updated point balance. The merchant confirms the point balance availability and then provides a new point balance to the electronic wallet, reflecting subtraction of the points redeemed for cash. The new point balance is provided to the mobile device for display.

In step 505, the appropriate cash value is provisioned to the consumer's electronic wallet (or the friend's wallet, if chosen) as a credit to an existing card in the electronic wallet or as a new prepaid/gift card. In some examples, a message may be displayed on the mobile device to this effect, as well as confirming redemption of the points.

FIGS. 6A and 6B are representative views of interfaces presented to a consumer according to an example embodiment.

For example, FIG. 6A depicts a series of consumer (or other user) interfaces on a mobile device for adding a loyalty card to the mobile phone's directory of loyalty cards which can be used according to the invention.

As explained above, one option for prompting a consumer to enroll in a loyalty card program is to include available loyalty cards in a list of cards on the mobile device's display.

Thus, as shown in display 601, a MoCom directory allows a user to search through available loyalty cards and/or other offers, which in turn may be distributed from the MoCom system. Via the directory, the consumer may view partners and services available from the partners, such as offers and loyalty cards. In some embodiments, the directory may correspond to a master list of all loyalty card programs and offers present on the mobile device. Of course, the display may also include loyalty cards in which the consumer has already enrolled with the corresponding program.

In the example of FIG. 6A, an envelope or other icon to the right of the text information entry card may indicate that the user has not yet enrolled in the loyalty card program for the corresponding card. Thus, the system stores a directory of service providers, and a display of the service providers is provided at the mobile device to enable applying the loyalty card to an existing transaction.

As shown in display 601, a user has selected to add a promoted loyalty card via a touch on the corresponding area in the card list.

In display 602, the consumer is shown a screen in which to add the loyalty card. In the example shown, the loyalty card can be entered into the mobile device by entering a corresponding number or alphanumeric sequence, and thus a keypad is presented on the mobile device display for entry of the number or alphanumeric sequence.

In display 603, the consumer selects to submit the entered number or alphanumeric sequence.

In display 604, the newly-added card is shown as added to the directory.

For purposes of conciseness, FIG. 6A only depicts views for adding a card, but it should be understood that various other operations can be performed including, for example, editing or updating loyalty card information, removing a loyalty card, presenting loyalty credentials at a point of sale transaction (including contactless transactions), and the like. In addition, notifications related to loyalty card information may be displayed on the mobile device, such as a notification that loyalty card details have been sent following a transaction.

FIG. 6B depicts other example user interfaces. For example, detailed view 605 shows a detailed view of a particular loyalty card, which may be obtained by, for example, selecting the loyalty card from the directory of cards in FIG. 6A. The detailed view 605 includes an enlarged image of the loyalty card graphic and corresponding name, as well as the loyalty card number. Detailed card view 605 further includes a barcode, which may be scannable at a terminal (if necessary) to submit the loyalty card information if, for example, contactless transmission is not possible.

Display 606 shows an example of how a loyalty card may be displayed on a card list. As shown, a smaller version of the card graphic is displayed, followed by the name and number of the card, and an icon allowing editing or adding of additional information.

Display 607 depicts an example of a loyalty card list, which depicts images and brief information focused on loyalty cards (as opposed to offers and payment cards). From the loyalty card list, the consumer can select a loyalty card to use for a particular transaction.

Of course, FIGS. 6A and 6B are only example views of such interfaces, and of course other views and arrangements are possible.

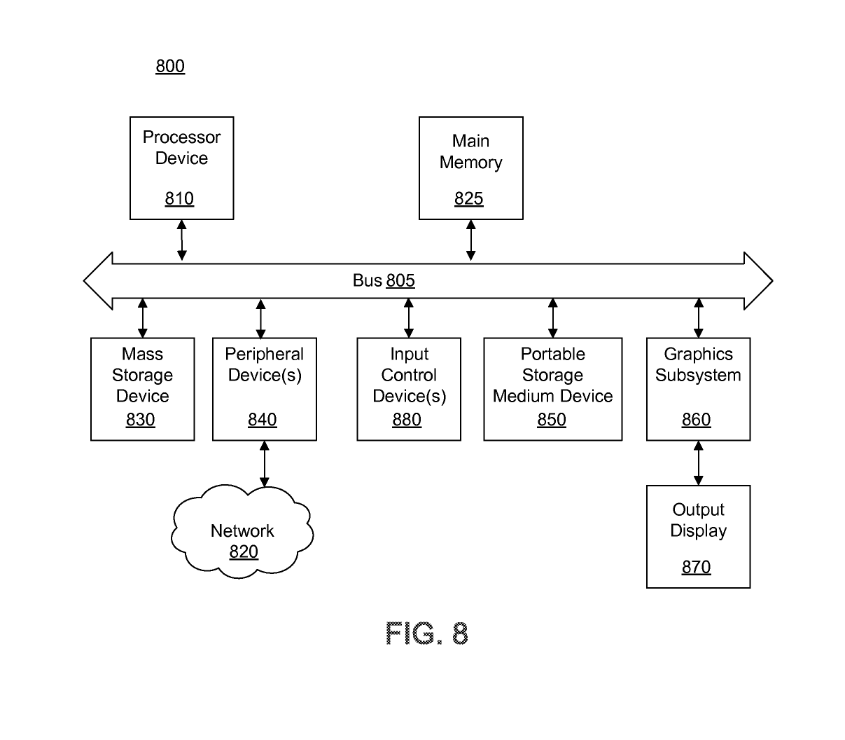

FIG. 8 is a block diagram of a general and/or special purpose computer 800, which may be a general and/or special purpose computing device, in accordance with some of the example embodiments of the invention. The computer 800 may be, for example, a consumer device, a consumer computer, a client computer and/or a server computer, among other things.

The computer 800 may include without limitation a processor device 810, a main memory 825, and an interconnect bus 805. The processor device 810 may include without limitation a single microprocessor, or may include a plurality of microprocessors for configuring the computer 800 as a multi-processor system. The main memory 825 stores, among other things, instructions and/or data for execution by the processor device 810. The main memory 825 may include banks of dynamic random access memory (DRAM), as well as cache memory.

The computer 800 may further include a mass storage device 830, peripheral device(s) 840, portable non-transitory storage medium device(s) 850, input control device(s) 880, a graphics subsystem 860, and/or an output display interface 870. For explanatory purposes, all components in the computer 800 are shown in FIG. 8 as being coupled via the bus 805. However, the computer 800 is not so limited. Devices of the computer 800 may be coupled via one or more data transport means. For example, the processor device 810 and/or the main memory 825 may be coupled via a local microprocessor bus. The mass storage device 830, peripheral device(s) 840, portable storage medium device(s) 850, and/or graphics subsystem 860 may be coupled via one or more input/output (I/O) buses. The mass storage device 830 may be a nonvolatile storage device for storing data and/or instructions for use by the processor device 810. The mass storage device 830 may be implemented, for example, with a magnetic disk drive or an optical disk drive. In a software embodiment, the mass storage device 830 is configured for loading contents of the mass storage device 830 into the main memory 825.

The portable storage medium device 850 operates in conjunction with a nonvolatile portable storage medium, such as, for example, a compact disc read only memory (CD-ROM), to input and output data and code to and from the computer 800. In some embodiments, the software for storing information may be stored on a portable storage medium, and may be inputted into the computer 800 via the portable storage medium device 850. The peripheral device(s) 840 may include any type of computer support device, such as, for example, an input/output (I/O) interface configured to add additional functionality to the computer 800. For example, the peripheral device(s) 840 may include a network interface card for interfacing the computer 800 with a network 820.

The input control device(s) 880 provide a portion of the consumer interface for a consumer of the computer 800. The input control device(s) 880 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 800 may include the graphics subsystem 860 and the output display 870. The output display 870 may include a cathode ray tube (CRT) display and/or a liquid crystal display (LCD). The graphics subsystem 860 receives textual and graphical information, and processes the information for output to the output display 870.

Each component of the computer 800 may represent a broad category of a computer component of a general and/or special purpose computer. Components of the computer 800 are not limited to the specific implementations provided here.

The example embodiments of the invention may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a processor device 810 typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a processor device 810 typically includes software resident on a storage media (e.g., a disk drive or memory card), which, when executed, directs the processor device 810 in performing transmission and reception functions. The processor device software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

Although for convenience processor device 810 is shown as being a single CPU, in other example embodiments processor device 810 may include plural separate CPUs, wherein each is dedicated to a separate application, such as, for example, a data application, a voice application, and a video application.

Software embodiments of the example embodiments presented herein may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the FIGS. 1-8 are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing service provider loyalty programs, comprising:
a processor configured to:
generate loyalty program information associated with a service provider, wherein the loyalty program information defines a loyalty program;
enable enrollment of a mobile device in the loyalty program, wherein an electronic loyalty card based on the loyalty program is stored at the mobile device after enrollment;
enable redemption of loyalty program information associated with the loyalty card at a transaction location; and
reconcile the loyalty program information between the service provider and the mobile device.

2. The system according to claim 1, wherein the system stores a directory of service providers, and wherein a display of the service providers is provided at the mobile device to enable applying the loyalty card to an existing transaction.

3. The system according to claim 1, wherein the loyalty program information is redeemed during a corresponding transaction by moving the mobile device near a reader at the transaction location.

4. The system according to claim 3, wherein the loyalty program information is transmitted sequentially prior to or following payment information, in a single transaction.

5. The system according to claim 1, wherein the mobile device is enrolled with the loyalty program via a web page associated with the service provider.

6. The system according to claim 1, wherein the mobile device is enrolled with the loyalty program based on a list of service providers distributed to the mobile device.

7. The system according to claim 1, wherein the mobile device is enrolled with the loyalty program based on a prompt received after near-field communication between the mobile device and a reader at the transaction location.

8. The system according to claim 1, wherein the mobile device is enrolled with the loyalty program based on a prompt received after reading an image with the mobile device.

9. The system according to claim 1, wherein the loyalty program information from the mobile device is redeemed for monetary value.

10. The system according to claim 1, wherein the loyalty program information is transmitted at a transaction by the mobile device, along with redemption of an offer provided by the service provider.

11. A method for managing service provider loyalty programs, comprising:
generating loyalty program information associated with a service provider, wherein the loyalty program information defines a loyalty program;
enabling enrollment of a mobile device in the loyalty program, wherein an electronic loyalty card based on the loyalty program is stored at the mobile device after enrollment;
enabling redemption of loyalty program information associated with the loyalty card at a transaction location; and
reconciling the loyalty program information between the service provider and the mobile device.

12. The method according to claim 11, wherein a directory of service providers is stored, and wherein a display of the service providers is provided at the mobile device to enable applying the loyalty card to an existing transaction.

13. The method according to claim 11, wherein the loyalty program information is redeemed during a corresponding transaction by moving the mobile device near a reader at the transaction location.

14. The method according to claim 13, wherein the loyalty program information is transmitted sequentially prior to or following payment information, in a single transaction.

15. The method according to claim 11, wherein the mobile device is enrolled with the loyalty program via a web page associated with the service provider.

16. The method according to claim 11, wherein the mobile device is enrolled with the loyalty program based on a list of service providers distributed to the mobile device.

17. The method according to claim 11, wherein the mobile device is enrolled with the loyalty program based on a prompt received after near-field communication between the mobile device and a reader at the transaction location.

18. The method according to claim 11, wherein the mobile device is enrolled with the loyalty program based on a prompt received after reading an image with the mobile device.

19. The method according to claim 11, wherein the loyalty program information from the mobile device is redeemed for monetary value.

20. The method according to claim 11, wherein loyalty program information is transmitted at a transaction by the mobile device, along with redemption of an offer provided by the service provider.

21. A non-transitory computer-readable medium having stored thereon sequences of instructions, the sequences of instructions including instructions which when executed by a computer system causes the computer system to perform:
generating loyalty program information associated with a service provider, wherein the loyalty program information defines a loyalty program;
enabling enrollment of a mobile device in the loyalty program, wherein an electronic loyalty card based on the loyalty program is stored at the mobile device after enrollment;
enabling redemption of loyalty program information associated with the loyalty card at a transaction location; and
reconciling the loyalty program information between the service provider and the mobile device.

22. The computer-readable medium according to claim 21, wherein a directory of service providers is stored, and wherein a display of the service providers is provided at the mobile device to enable applying the loyalty card to an existing transaction.
